(19) United States
(12) Patent Application Publication
(10) Pub. No.: US 2023/0362311 A1
(43) Pub. Date: Nov. 9, 2023

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Hiroyuki TAKAYAMA, Kanagawa (JP)

(73) Assignee: FUJIFILM Business Innovation Corp., Tokyo (JP)

(21) Appl. No.: 17/973,122

(22) Filed: Oct. 25, 2022

(30) Foreign Application Priority Data
May 9, 2022 (JP) 2022-077236

(51) Int. Cl. H04N 1/32

(52) U.S. Cl. CPC H04N 1/32363; H04N 1/32523

(57) ABSTRACT

An information processing apparatus includes a processor configured to: acquire image data with a destination; acquire a condition that is pre-defined as to whether image data transmission is permitted or not; and if whether the image data transmission is permitted or not is difficult to determine in accordance with the condition, perform control not to transmit the image data to the destination but to present the condition to an administrator that manages the condition.

### CROSS-REFERENCE TO RELATED APPLICATIONS

This application is based on and claims priority under 35 USC 119 from Japanese Patent Application No. 2022-077236 filed May 9, 2022.

### BACKGROUND

### (I) Technical Field

The present disclosure relates to an information processing apparatus, a non-transitory computer readable medium, and an information processing method.

### (II) Related Art

Japanese Patent No. 6039826 discloses a fraudulent access detection method that updates a detection rule by generating a regular expression of a uniform resource location (URL). The regular expression of the URL is used to detect an unauthorized access by tracing an access behavior of malware obtained from malware analysis results. The fraudulent access detection method includes extracting a malware feature value by tracing and analyzing an access behavior of malware that is collected by an analyzer or through malware infection over a network. The fraudulent access detection method further includes searching for, on an access feature value memory, a similar URL satisfying a distance within a predetermined threshold value, with a malware feature value being used as a query. The access feature value memory extracts an access feature value from a past access log over the network and stores the access feature value. The fraudulent access detection method further includes generating a regular expression URL in accordance with a connection destination URL of the malware feature value and the similar URL that is hit in the search. The fraudulent access detection method further includes setting the regular expression URL to be a new detection rule if pattern matching is applied to the regular expression URL and the connection destination URL included in the access log to calculate a match rate and the match rate is equal to or below a recommended value.

Technique referred to as data loss prevention (DLP) is available to transmit data from an apparatus to a destination. The DLP determines in accordance with a pre-defined policy whether to permit transmission of the data.

In the early stage of the development of an apparatus, a developer of the apparatus may wish to keep image data related to a design of the apparatus confidential and control disclosure of information. However, in the early stage of the development, there is no sufficient information about image data and it is difficult to define policy of the image data. Imperfection of the policy may lead to the leakage of the image data.

### SUMMARY

Aspects of non-limiting embodiments of the present disclosure relate to providing an information processing apparatus, a non-transitory computer readable medium, and an information processing method controlling, with a pre-defined condition, transmission of an image that is difficult to determine whether to permit transmission of the image data.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: acquire image data with a destination; acquire a condition that is pre-defined as to whether image data transmission is permitted or not; and if whether the image data transmission is permitted or not is difficult to determine in accordance with the condition, perform control not to transmit the image data to the destination but to present the condition to an administrator that manages the condition.

### BRIEF DESCRIPTION OF THE DRAWINGS

Exemplary embodiments of the present disclosure will be described in detail based on the following figures, wherein:

FIG. 1 illustrates a configuration example of an information processing system;

FIG. 2 illustrates a functional configuration example of an information processing apparatus of a first exemplary embodiment;

FIG. 3 illustrates an electrical configuration example of the information processing apparatus;

FIG. 4 is a flowchart illustrating a flow example of a verification process of a document in accordance with the first exemplary embodiment;

FIG. 5 illustrates an extraction example of an image;

FIG. 6 illustrates an example of document attribute information;

FIG. 7 is a flowchart illustrating a flow example of a protection process of an undetermined document in accordance with the first exemplary embodiment;

FIG. 8 illustrates a functional configuration example of an information processing apparatus of a second exemplary embodiment;

FIG. 9 is a flowchart illustrating a flow example of a verification process of a document in accordance with the second exemplary embodiment;

FIG. 10 illustrates an operation example in which an image is replaced with a dummy image;

FIG. 11 is a flowchart illustrating an modification example of the verification process of the document in accordance with the second exemplary embodiment;

FIG. 12 is a flowchart illustrating a flow example of a protection process of an undetermined document in accordance with the second exemplary embodiment;

FIG. 13 illustrates how the dummy image is replaced back with an original image;

FIG. 14 illustrates how the dummy image is replaced back with a protection notice image;

FIG. 15 illustrates an example of the document attribute information on an undetermined document that has undergone image replacement;

FIG. 16 illustrates how multiple undetermined documents are grouped;

FIG. 17 illustrates an example of the document attribute information on documents that have been grouped;

FIG. 18 illustrates an example of the document attribute information in which information on a document is set;

FIG. 19 illustrates a display example on a display of an administrator terminal;

FIG. 20 illustrates a functional configuration example of an information processing apparatus of a third exemplary embodiment;

FIG. 21 is a flowchart illustrating a flow example of a protection process of an undetermined document in accordance with the third exemplary embodiment; and

FIG. 22 illustrates an example of a policy.

### DETAILED DESCRIPTION

Embodiments of the disclosure are described with reference to the drawings. Like elements and like operations are designated with the same reference numerals and the discussion thereof is not duplicated.

### First Exemplary Embodiment

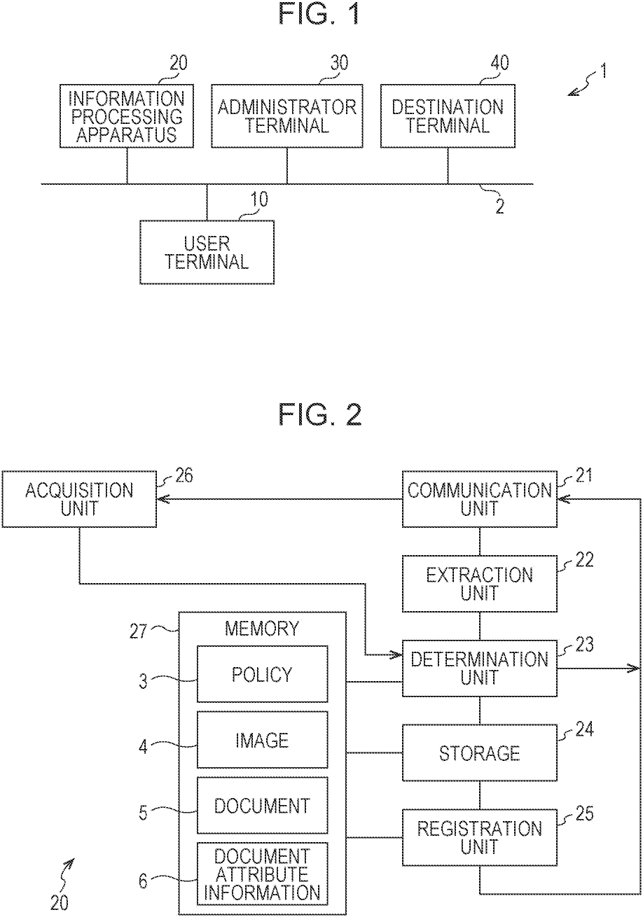

FIG. 1 illustrates a configuration of an information processing system 1 of a first exemplary embodiment. Referring to FIG. 1, the information processing system 1 includes a user terminal 10, information processing apparatus 20, administrator terminal 30, and destination terminal 40. The user terminal 10, information processing apparatus 20, administrator terminal 30, and destination terminal 40 are interconnected to each other via a communication network 2.

The user terminal 10 is a terminal operated by a user. The user may transmit a specified document 5 (see FIG. 5) via the information processing apparatus 20 by operating the user terminal 10.

The document 5 is a document file as a collection of data. For example, the document 5 includes an image portion, such as photographs, drawings, and illustrations, and a text portion represented by text. The document 5 includes data representing an image 4 (see FIG. 5) and is thus image data.

The user terminal 10 may be any apparatus as long as the apparatus has a function of transmitting to a destination the document 5 via the information processing apparatus 20 and the communication network 2. A computer having a communication function implemented via the communication network 2 is an example of the user terminal 10. In the discussion that follows, the user terminal 10 is an image processing apparatus.

The image processing apparatus performs a process on the image 4. The process performed on the image 4 includes a scan function that reads, as the document 5, contents written on a recording medium, such as a paper sheet, a copy function that forms contents of the document 5 read via the scan function on a recording medium using a coloring material, and a print function that forms the contents of the document 5 received via the communication network 2 on a recording medium using a color material.

The user transmits the generated document 5 to a specified destination using the scan function of the user terminal 10. Information related to the destination specified by the user is attached to the document 5 transmitted by the user terminal 10.

Before the document 5 is transmitted from the user terminal 10 to the specified destination, the information processing apparatus 20 receives first the document 5 from the user terminal 10 and determines, in accordance with a policy 3 (see FIG. 2) serving as a pre-defined condition, whether the document 5 includes the image 4 that is to be kept confidential. If the document 5 does not include the image 4 that is to be kept confidential, the information processing apparatus 20 transmits the received document 5 to the destination specified by a user. If the document 5 includes the image 4 that is to be kept confidential, the information processing apparatus 20 does not cause the document 5 to be transmitted to the specified destination. On the other hand, it is difficult to determine according to the pre-defined policy 3 whether the image 4 included in the document 5 is a confidential target, the information processing apparatus 20 handles the document 5 in accordance with a verification process of the document 5 described below such that the document 5 including confidential information is not transmitted to the specified destination.

The administrator terminal 30 is operated by an administrator that determines whether the document 5 includes the confidential information. The administrator terminal 30 receives as appropriate from the information processing apparatus 20 a determination request to determine whether the document 5 includes the confidential information. In such a case, the administrator terminal 30 receives, from the administrator, an instruction including determination results about the confidential information and transmits the received instruction to the information processing apparatus 20.

The destination terminal 40 serves as the destination of the document 5 transmitted from the user terminal 10. The destination terminal 40 may be implemented by cloud computing. The user of the destination terminal 40 is free from any restrictions and may view the document 5, transmitted from the user terminal 10, on the destination terminal 40. If the destination of the document 5 is a specific user specified, for example, by a mail address, a terminal that the user specified as the destination operates and displays a mail on is the destination terminal 40.

For convenience of explanation, FIG. 1 illustrates a single user terminal 10 and a single destination terminal 40 connected to each other via the communication network 2. Alternatively, multiple user terminals 10 and multiple destination terminals 40 are interconnected to each other via the communication network 2. The information processing apparatus 20 may also serve as the administrator terminal 30. In such a case, the administrator terminal 30 is not employed in the information processing system 1.

No restrictions are imposed on a connection configuration of the communication network 2 in the information processing system 1. For example, the connection configuration of the communication network 2 may be a wireless communication, a wired communication, or a combination thereof. The communication network 2 may be an exclusive network or a public network, such as the Internet.

FIG. 2 illustrates a functional configuration of the information processing apparatus 20 of the first exemplary embodiment. Referring to FIG. 2, the information processing apparatus 20 includes functional blocks including a communication unit 21, extraction unit 22, determination unit 23, storage 24, registration unit 25, acquisition unit 26, and memory 27.

The communication unit 21 transmits or receives data to or from each terminal included in the information processing system 1 via the communication network 2. Specifically, the communication unit 21 receives the document 5 that the user has transmitted from the user terminal 10 toward the destination terminal 40 while transmitting the received document 5 to the destination terminal 40 in accordance with determination results described below and provided by the determination unit 23. If the determination results of the determination unit 23 are indefinite, the communication unit 21 transmits the document 5 to the administrator terminal 30 in response to the instruction from the registration unit 25 before transmitting the document 5 to the destination terminal 40, and receives from the administrator terminal 30 an instruction including determination results of the administrator related to the confidential information on the document 5. In the discussion that follows, the instruction including the determination results of the administrator on the confidential information on the document 5 is referred to as an “determination instruction.”

The extraction unit 22 identifies the position of the image 4 in the document 5 and extracts the image 4 from the document 5.

By referring to the policy 3 pre-stored on the memory 27, the determination unit 23 determines whether the transmission of the document 5 to the destination terminal 40 specified by the user is permitted. If the determination results of the administrator related to the confidential information on the document 5 are received from the administrator terminal 30 via the communication unit 21 and acquisition unit 26, the determination unit 23 determines in accordance with the determination results whether the transmission of the document 5 to the destination terminal 40 specified by the user is permitted.

If the determination unit 23 is unable to determine in accordance with the policy 3 whether the transmission of the document 5 to the destination terminal 40 specified by the user is permitted, the storage 24 stores on the memory 27 the document 5 and the image 4 extracted by the extraction unit 22.

If the determination unit 23 has been unable to determine in accordance with the reference to the policy 3 whether the transmission of the document 5 to the destination terminal 40 is permitted, the registration unit 25 generates document attribute information 6 on the document 5 and stores the generated document attribute information 6 on the memory 27. For convenience of explanation, if the determination unit 23 has been unable to determine in accordance with the reference to the policy 3 whether the transmission of the document 5 to the destination terminal 40 is permitted, that document 5 is occasionally referred to as an undetermined document 5.

The registration unit 25 instructs the communication unit 21 to transmit to a predetermined terminal the undetermined document 5 with the document attribute information 6 thereof registered.

When the undetermined document 5 is transmitted to the administrator terminal 30, the communication unit 21 receives the determination instruction of the administrator. Upon receiving the determination instruction from the administrator terminal 30, the communication unit 21 notifies the acquisition unit 26 that the determination instruction has been received.

The acquisition unit 26 receives a reception notice of the determination instruction from the communication unit 21 and acquires from the determination instruction the determination results of the administrator related to the confidential information on the undetermined document 5 and notifies the determination unit 23 of the acquired determination results.

The memory 27 stores a variety of information on a memory device. Information to be stored on the memory device by the memory 27 includes the policy 3, image 4, document 5, and document attribute information 6.

The policy 3 is information that pre-defines whether the image 4 included in the document 5 is to be a confidential target. The information processing apparatus 20 performs control such that the document 5 including the image 4 as a confidential target is not transmitted to the destination terminal 40 and such that the document 5 not including the image 4 as the confidential target is transmitted to the destination terminal 40. The policy 3 may thus be referred to as information that pre-defines a condition that is used to determine whether the transmission of the document 5 including the image 4 is permitted.

The policy 3 may be sorted into a white list that defines information on the image 4 that is not the confidential target and a black list that defines the information on the image 4 serving as the confidential target. It is noted that the administrator pre-stores the policy 3 on a memory device of the information processing apparatus 20.

The document attribute information 6 represents an attribute of the document 5 stored on the memory device. The attribute of the document 5 is a feature of the document 5 and information that is used in handling the document 5 on the information processing apparatus 20. Contents of the document attribute information 6 are described below.

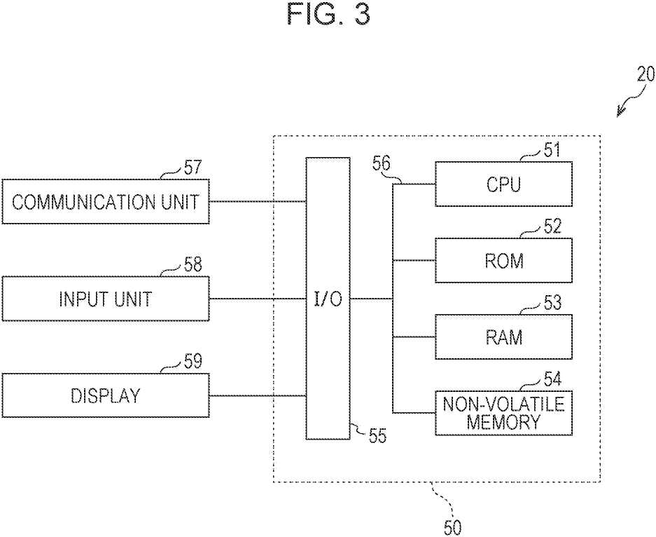

The information processing apparatus 20 may be a computer 50. FIG. 3 illustrates an electrical configuration of the information processing apparatus 20 implemented by the computer 50.

The computer 50 includes a central processing unit (CPU) 51 performing functions of functional blocks of the information processing apparatus 20 in FIG. 2, a read-only memory (ROM) 52 storing a startup program (basic input output system: BIOS) performing a startup operation of the computer 50, a random-access memory (RAM) 53 used as a temporary working area of the CPU 51, a non-volatile memory 54, and an input and output interface (I/O) 55. The CPU 51, ROM 52, RAM 53, non-volatile memory 54 and I/O 55 are interconnected to each other via a bus 56.

The non-volatile memory 54 is an example of the memory device that continues storing information even while power supplying to the non-volatile memory 54 is interrupted. The non-volatile memory 54 may be a semiconductor memory or a hard disk. The non-volatile memory 54 thus stores an information processing program that causes the computer 50 to operate as the information processing apparatus 20. The memory 27 causes the non-volatile memory 54 to store information that is to be continuously stored even while the power supplying to the information processing apparatus 20 is interrupted. Such information includes the policy 3, image 4, document 5, and document attribute information 6.

The I/O 55 is connected to a communication unit 57, input unit 58, and display 59.

The communication unit 57 is connected to the communication network 2 and supports a communication protocol that allows data communication to be performed with the user terminal 10, administrator terminal 30, and destination terminal 40.

The input unit 58 receives a touch operation on the information processing apparatus 20 and notifies the CPU 51 of the touch operation and includes, for example, a button, touch panel, keyboard, mouse, pointing device, and the like.

The display 59 visually displays information processed by the CPU 51 and includes, for example, a liquid-crystal display or an electroluminescence (EL) display.

The verification process of the document 5 to be performed by the information processing apparatus 20 is described below.

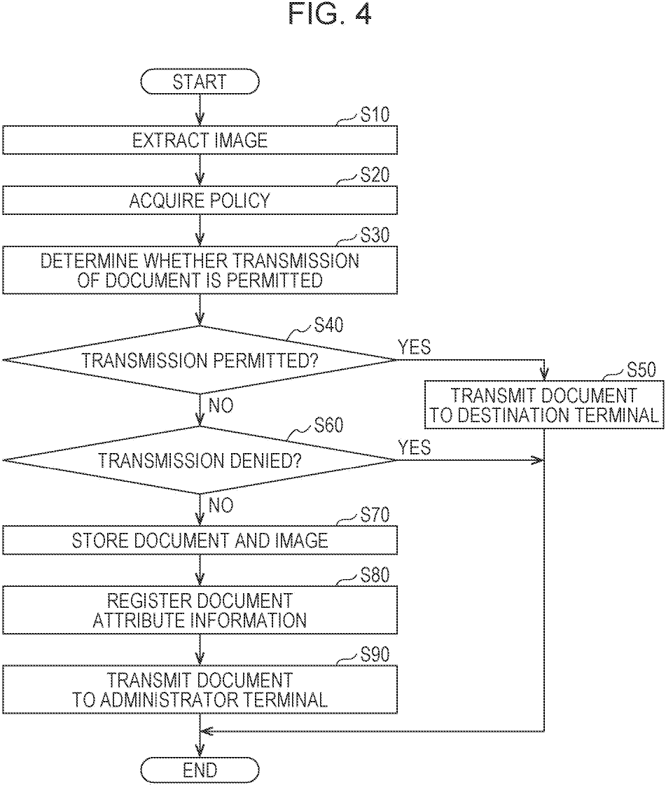

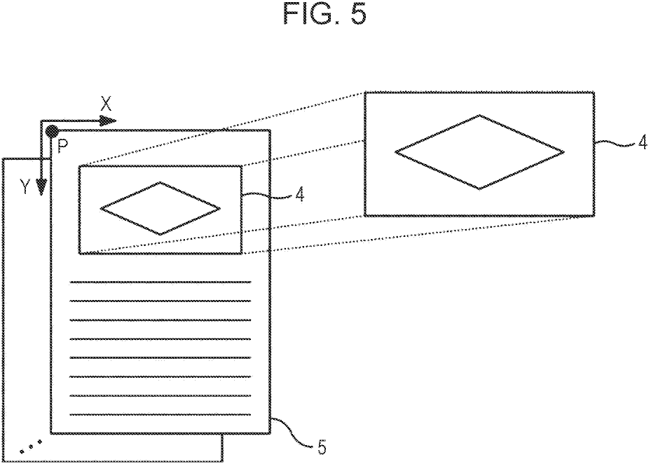

FIG. 4 is a flowchart illustrating a flow example of the verification process of the document 5 performed by the CPU 51 in the information processing apparatus 20 when the document 5 transmitted from the user terminal 10 toward the destination terminal 40 is received.

The information processing program defining the verification process of the document 5 is pre-stored on the non-volatile memory 54 in the information processing apparatus 20. The CPU 51 in the information processing apparatus 20 reads the information processing program from the non-volatile memory 54 and performs the verification process of the document 5. It is noted that the policy 3 is pre-stored on the non-volatile memory 54.

In step S10, the CPU 51 extracts the image 4 from the received document 5. FIG. 5 illustrates an extracted example of the image 4. The document 5 includes multiple pages and a two-dimensional coordinate system with a predetermined point serving as an origin P defined in each page. Position in the document 5 is represented by page information and coordinate values in the two-dimensional coordinate system in each page. In the extracted example of the image 4 in FIG. 5, a top-left corner point on the first page of the document 5 is set to be as the origin P, an X axis is set along the horizontal direction of the document 5, and a Y axis is set along the vertical direction of the document 5.

The CPU 51 implements image recognition technology, such as pattern recognition or image recognition based on a learning model learned through deep learning, extracts the image 4 from the document 5, and then stores the image 4 on the RAM 53. The CPU 51 also stores, as the position of the extracted image 4 in the document 5, coordinate values of a predetermined position (for example, the position of the top-left corner point in the extracted image 4) of the extracted image 4 on the RAM 53.

In step S20, the CPU 51 acquires the document 5 from the non-volatile memory 54. The white list of the policy 3 pre-defines a feature value representing the feature of the image 4 indicating a grant to the permission to transmit the image 4 to the destination terminal 40. The black list of the policy 3 pre-defines a feature value representing the feature of the image 4 indicating a denial to the permission to transmit the image 4 to the destination terminal 40. The feature value of the image 4 indicating the grant to the permission to transmit and the feature value of the image 4 indicating the denial to the permission to transmit may be represented by a pattern definition. The pattern definition employs, as an expression method of the policy 3, a regular expression that determines character string information extracted from the image 4.

In step S30, the CPU 51 determines whether the transmission of the received document 5 is permitted. Specifically, if the feature value of the image 4 extracted in step S10 is similar to the feature value of the image 4 defined in the white list, the CPU 51 determines that the extracted image 4 is not a confidential target. Since the received document 5 does not include the image 4 as the confidential target, the CPU 51 determines that the transmission of the document 5 to the destination terminal 40 is permitted.

If the feature value of the image 4 extracted in step S10 is similar to the feature value of the image 4 defined in the black list, the CPU 51 determines that the extracted image 4 is a confidential target. Since the received document 5 includes the image 4 as the confidential target, the CPU 51 determines that the transmission of the document 5 to the destination terminal 40 is not permitted.

The similarity of the feature values signifies that a distance between a feature vector generated from a feature value defined by the white list or the black list and a feature vector generated from a feature value of the extracted image 4 falls within a predetermined range. The distance of the feature vector is represented by a distance of related art, such as cosine distance.

The feature value of the image 4 extracted in step S10 is not similar to the feature value of the image 4 defined in the white list or the feature value of the image 4 defined in the black list, the CPU 51 determines that the received document 5 includes the image 4 that the policy 3 is difficult to determine in terms of whether the image 4 is the confidential target or not. In such a case, the CPU 51 determines that it is difficult to determine whether the transmission of the received document 5 to the destination terminal 40 is permitted.

In step S40, the CPU 51 determines in accordance with the determination results in step S30 whether the transmission of the received document 5 to the destination terminal 40 is permitted. If the received document 5 does include the image 4 as the confidential target, the transmission of the received document 5 to the destination terminal 40 is permitted, and the process proceeds to step S50.

In step S50, the CPU 51 ends the verification process of the document 5 in FIG. 4 by transmitting the received document 5 to the destination terminal 40. In this way, the document 5 received from the user terminal 10 will be viewed on the destination terminal 40.

If the CPU 51 determines in the determination operation in step S40 that the received document 5 is a document 5 including the image 4 serving as the confidential target, the process proceeds to step S60.

In step S60, the CPU 51 determines in accordance with the determination results in step S30 that the received document 5 is a document 5 that is difficult to transmit to the destination terminal 40. If the received document 5 is a document 5 including the image 4 serving as the confidential target, the permission of the transmission of the document 5 to the destination terminal 40 is not permitted and yes path is followed. The verification process of the document 5 illustrated in FIG. 4 is thus completed without transmitting the received document 5 to the destination terminal 40. The document 5 received from the user terminal 10 will not be viewed on the destination terminal 40.

If the determination operation in step S60 indicates that the received document 5 is not a document 5 including the image 4 serving as the confidential target, in other words, the received document 5 is the undetermined document 5, no path is followed and the process proceeds to step S70.

In step S70, the CPU 51 stores on the non-volatile memory 54 the image 4 extracted from the document 5 received in step S10 and the received document 5. Specifically, the CPU 51 stores the undetermined document 5 and the image 4 included in the undetermined document 5.

In step S80, the CPU 51 stores the document attribute information 6 on the received document 5 onto the non-volatile memory 54. The CPU 51 registers the document attribute information 6 on the undetermined document 5 on the memory device.

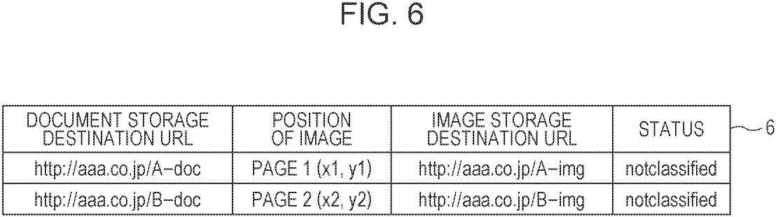

FIG. 6 illustrates an example of the document attribute information 6 registered on the non-volatile memory 54. The document attribute information 6 includes a document storage destination URL, image position, image storage destination URL, and status.

The URL of a storage destination of the undetermined document 5 registered on the memory device in step S70 is set as the document storage destination URL. The URL of a storage destination of the image 4 extracted from the undetermined document 5 registered on the memory device in step S70 is set as the image storage destination URL.

Coordinate values representing the position of the image 4 extracted from the undetermined document 5 in step S10 is set as the image position.

A value representing the status of the undetermined document 5 is set as the status. For example, the word “notclassified” signifies the status of the undetermined document 5 that is immediately after the registration with no process being performed on the undetermined document 5. The setting of the status is described below.

Items set in the document attribute information 6 are not limited to those in FIG. 6 and an item may be added or deleted as appropriate. For example, a document number uniquely identifying the document 5 may be added to the document attribute information 6.

In step S90 in FIG. 4, the CPU 51 transmits the received document 5 to the administrator terminal 30 and then completes the verification process of the document 5 illustrated in FIG. 4. If the received document 5 is the undetermined document 5, the CPU 51 performs control to present the received document 5 to the administrator (specifically, the administrator terminal 30) that manages the policy 3, without transmitting the received document 5 to a destination specified by the user (specifically, the destination terminal 40).

The CPU 51 does not necessarily transmit the undetermined document 5 to the administrator terminal 30 but simply sets the undetermined document 5 to be in a state that allows the administrator to verify the image 4 included in the document 5. The CPU 51 may thus transmit only the image 4 included in the undetermined document 5 to the administrator terminal 30 or may transmit URL information indicative of the storage location of the undetermined document 5 and URL information indicative of the storage location of the image 4 included in the undetermined document 5.

If the administrator operates the information processing apparatus 20, the CPU 51 may simply set the image 4 to be in a state that allows the administrator to verify the image 4 included in the undetermined document 5. Specifically, the undetermined document 5 and the image 4 included in the undetermined document 5 are displayed on the display 59 of the information processing apparatus 20.

An operation example of the CPU 51 setting the image 4 included in the undetermined document 5 to be in the state that allows the administrator to verify the image 4 is referred to as an operation example of the CPU 51 “presenting the image 4 to the administrator.”

As the operation example of the CPU 51 presenting the image 4 to the administrator is described with reference to transmitting the undetermined document 5 to the administrator terminal 30.

In response, using the administrator terminal 30, the administrator verifies the image 4 included in the undetermined document 5 received from the information processing apparatus 20 and then determines whether the undetermined document 5 is the document 5 not including the image 4 serving as the confidential target and is thus transmission-permitted. Upon receiving determination results from the administrator, the administrator terminal 30 transmits to the information processing apparatus 20 the determination instruction including the determination results.

If the information processing apparatus 20 has transmitted URL information to the administrator terminal 30, the administrator may access the storage location of data written in the URL information using the administrator terminal 30 and view the undetermined document 5 or the image 4 included in the undetermined document 5.

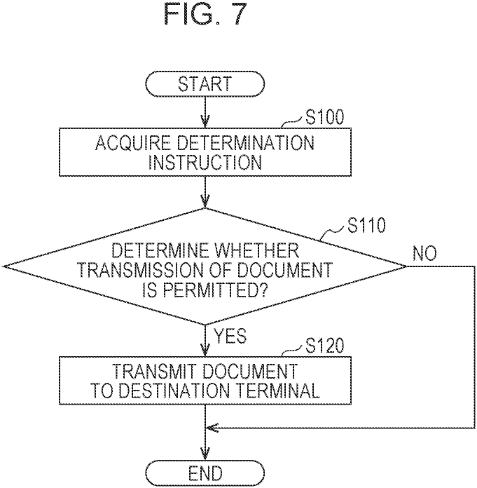

FIG. 7 is a flowchart illustrating a flow example of a protection process of the undetermined document 5 performed by the CPU 51 in the information processing apparatus 20 when the information processing apparatus 20 receives the determination instruction from the administrator terminal 30.

The information processing program defining the protection process of the undetermined document 5 is stored on the non-volatile memory 54 in the information processing apparatus 20. The CPU 51 in the information processing apparatus 20 reads the information processing program from the non-volatile memory 54 and performs the protection process of the undetermined document 5.

In step S100, the CPU 51 acquires the determination instruction received from the administrator terminal 30.

In step S110, the CPU 51 references the determination results included in the determination instruction acquired in step S10 and determines whether the administrator has determined that the undetermined document 5 is a transmission-permitted document 5. If the determination results indicate that the administrator has determined that the undetermined document 5 is a transmission-permitted document 5, the process proceeds to step S120.

In step S120, the CPU 51 references the document attribute information 6, acquires from the non-volatile memory 54 the undetermined document 5, transmitted to the administrator terminal 30 in step S90 in FIG. 4, transmits the undetermined document 5 to the destination terminal 40, and ends the protection process of the undetermined document 5 in FIG. 7. Specifically, the CPU 51 transmits the undetermined document 5, which has not been transmitted to the destination terminal 40 in the verification process of the document 5 illustrated in FIG. 4, to the destination terminal 40.

If the determination operation in step S110 determines in response to the determination results that the administrator has determined that the undetermined document 5 is not a transmission-permitted document 5, the CPU 51 ends the protection process of the undetermined document 5 in FIG. 7 without transmitting to the destination terminal 40 the undetermined document 5 transmitted to the administrator terminal 30 in step S90 in FIG. 4.

At the early stage of the development of a product, the study of the design of the product is typically not in progress and it is difficult to pre-define a shape that is set to be confidential. It is thus difficult to pre-define the policy 3 that controls the leakage of the document 5 including the image 4 representing the design of the product under development. If the information processing apparatus 20 of the first exemplary embodiment has difficulty in determining whether to permit the transmission of the document 5 to the destination terminal 40 in accordance with the policy 3, the administrator may determine whether to permit the transmission. The document 5 that is determined to be transmission-not -permitted is not transmitted to the destination terminal 40.

### Second Exemplary Embodiment

If the administrator determines that the undetermined document 5 includes the image 4 serving as the confidential target, the information processing apparatus 20 of the first exemplary embodiment does not transmit the undetermined document 5 to the destination terminal 40. However, it may be sometimes acceptable to expose a text portion of the document 5. If the undetermined document 5 includes multiple images 4 and thus includes a mixture of the images 4 that may be acceptably disclosed and the images 4 that are to be kept confidential, the images 4 that may be acceptably disclosed are disclosed as they are.

Even if the undetermined document 5 includes the image 4 serving as the confidential target, the information processing apparatus 20 of a second exemplary embodiment discloses a text portion of the undetermined document 5 and a portion as the image 4 that may be disclosed .

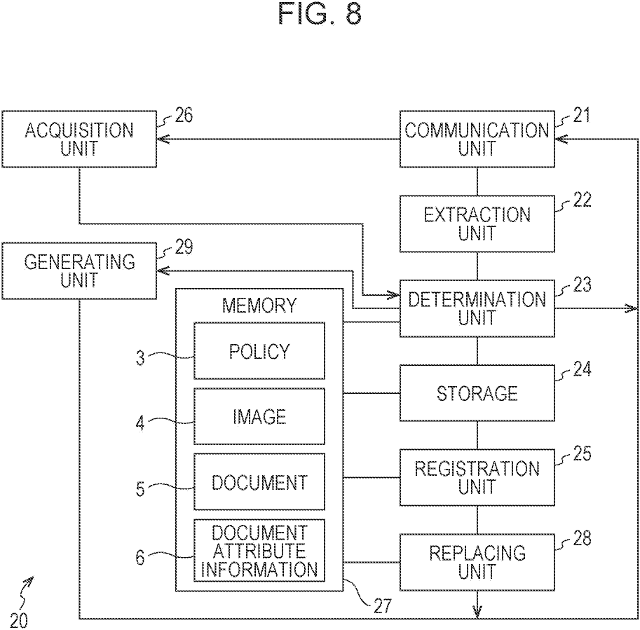

FIG. 8 illustrates a functional configuration of the information processing apparatus 20 of the second exemplary embodiment. The functional configuration in FIG. 8 is different from the functional configuration of the information processing apparatus 20 of the first exemplary embodiment illustrated in FIG. 2 in that a replacing unit 28 and generating unit 29 are included in FIG. 8.

The replacing unit 28 replaces the image 4 included in the undetermined document 5 with a dummy image 4A. The dummy image 4A is pre-stored on the memory device and is an image 4 not including confidential information.

In accordance with the determination results of the administrator related to whether to permit the transmission of the undetermined document 5, the generating unit 29 generates, from the undetermined document 5 with the image 4 replaced with the dummy image 4A, the document 5 to be transmitted to the destination terminal 40.

Since the electrical configuration of the information processing apparatus 20 of the second exemplary embodiment is identical to the electrical configuration of the information processing apparatus 20 of the first exemplary embodiment illustrated in FIG. 3, the discussion thereof is omitted herein.

The verification process of the document 5 performed by the information processing apparatus 20 of the second exemplary embodiment is described below.

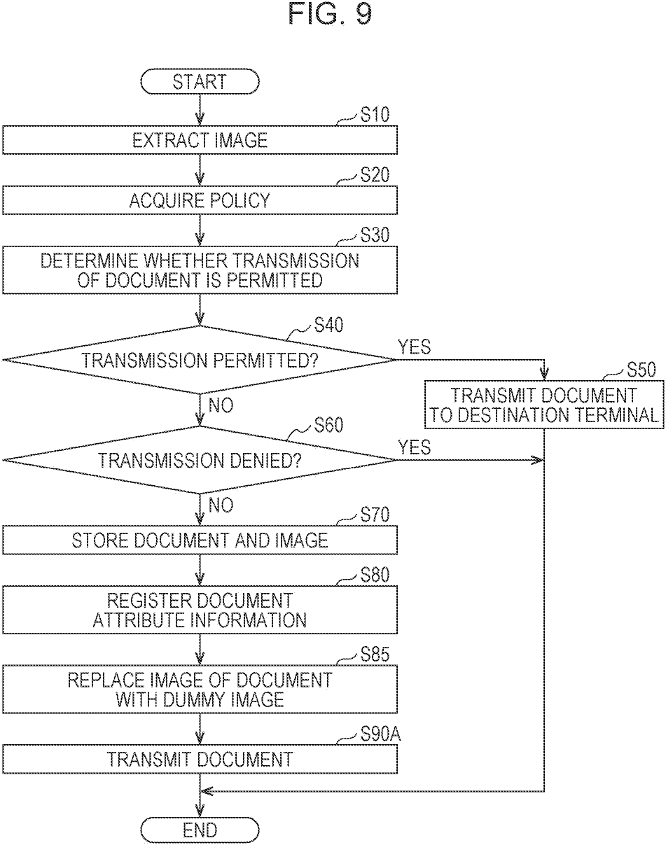

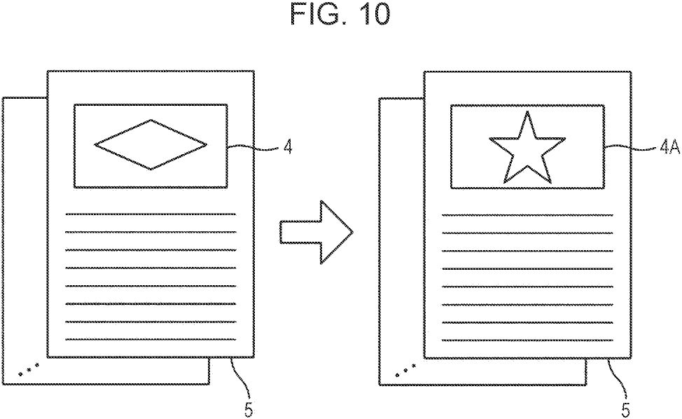

FIG. 9 is a flowchart illustrating a flow example of the verification process of the document 5 performed by the CPU 51 in the information processing apparatus 20 of the second exemplary embodiment when the document 5 to be transmitted from the user terminal 10 toward the destination terminal 40 is received.

As in the first exemplary embodiment, the information processing program defining the verification process of the document 5 is pre-stored on the non-volatile memory 54 in the information processing apparatus 20. The CPU 51 in the information processing apparatus 20 reads the information processing program from the non-volatile memory 54 and then performs the verification process of the document 5. It is noted that the policy 3 is pre-stored on the non-volatile memory 54.

The flowchart of the verification process of the document 5 in FIG. 9 is different from the flowchart of the verification process of the document 5 of the first exemplary embodiment illustrated in FIG. 4 in that step S85 is added and step S90 in FIG. 4 is replaced with step S90A in the flowchart in FIG. 9. The rest of the process in FIG. 9 is identical to the verification process of the document 5 of the first exemplary embodiment. The following discussion thus focuses on the difference from the verification process of the document 5 of the first exemplary embodiment.

If the document 5 received from the user terminal 10 is determined to be an undetermined document 5, the CPU 51 performs an operation in step S85 after storing the document attribute information 6 on the undetermined document 5 on the non-volatile memory 54 in step S80.

In step S85, the CPU 51 replaces the image 4 included in the undetermined document 5 with the dummy image 4A pre-stored on the non-volatile memory 54. FIG. 10 illustrates how the image 4 is replaced with the dummy image 4A. In this way, the undetermined document 5 becomes a document 5 that does not include the image 4 serving as confidential target and may thus be disclosed. The undetermined document 5 with the image 4 replaced with the dummy image 4A becomes an example of dummy image data.

In step S90A, the CPU 51 transmits to the administrator terminal 30 the undetermined document 5 with the image 4 not yet replaced with the dummy image 4A while transmitting to the destination terminal 40 the document 5 with the image 4 replaced with the dummy image 4A in step S85. The CPU 51 thus ends the verification process of the document 5 in FIG. 9.

According to the second exemplary embodiment, if the information processing apparatus 20 is unable to determine in accordance with the policy 3 whether the transmission of the document 5 to the destination terminal 40 is permitted, the information processing apparatus 20 replaces the image 4 with the dummy image 4A before transmitting the document 5 to the destination terminal 40. Furthermore, the information processing apparatus 20 transmits the undetermined document 5 to the administrator terminal 30 to notify the administrator that the undetermined document 5 with the image 4 replaced with the dummy image 4A has been transmitted to the destination terminal 40.

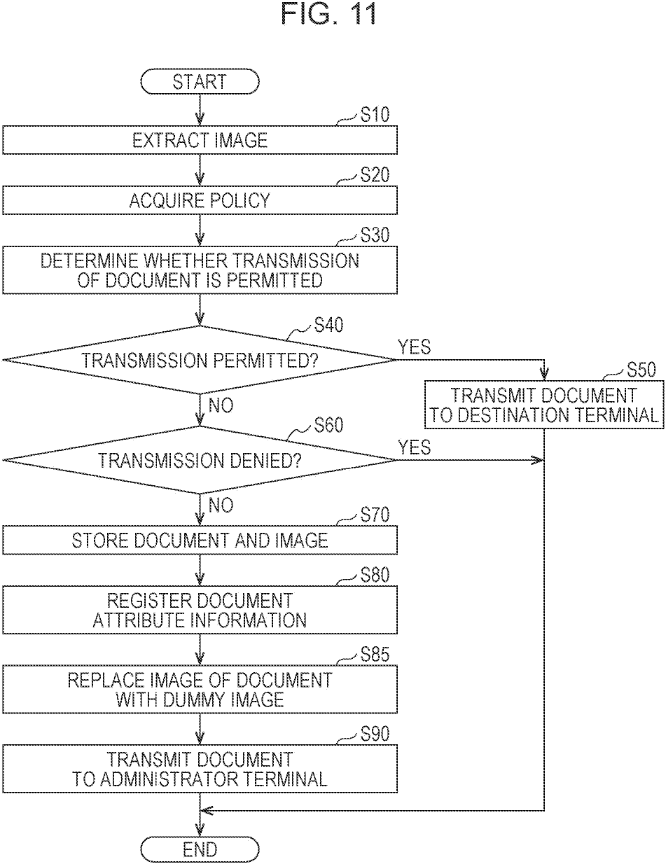

FIG. 11 is a flowchart illustrating a modification of the verification process of the document 5 of the second exemplary embodiment. When the received document 5 is determined to be an undetermined document 5, the image 4 included in the undetermined document 5 is replaced with the dummy image 4A in the verification process of the document 5 in FIG. 9 even if the image 4 is not the confidential target.

If the administrator determines that the document 5 including the image 4 to be replaced with the dummy image 4A is not the confidential target, the document 5 including the original image 4 prior to being replaced with the dummy image 4A is transmitted to the destination terminal 40 in the verification process of the document 5 illustrated in FIG. 11.

The flowchart of the verification process of the document 5 in FIG. 11 is different from the flowchart of the verification process of the document 5 in FIG. 9 in that step S90A is replaced with step S90 in the flowchart in FIG. 11 as in the verification process of the document 5 of the first exemplary embodiment.

Before transmitting the document 5 with the image 4 replaced with the dummy image 4A to the destination terminal 40, the CPU 51 transmits the original undetermined document 5 with the image 4 prior to being replaced with the dummy image 4A to the administrator terminal 30 and ends the verification process of the document 5 in FIG. 11.

The administrator verifies the image 4 included in the undetermined document 5 using the administrator terminal 30 and determines whether the undetermined document 5 is a transmission-permitted document 5 not including the image 4 serving as the confidential target. Upon receiving the determination results from the administrator, the administrator terminal 30 transmits to the information processing apparatus 20 the determination instruction including the determination results.

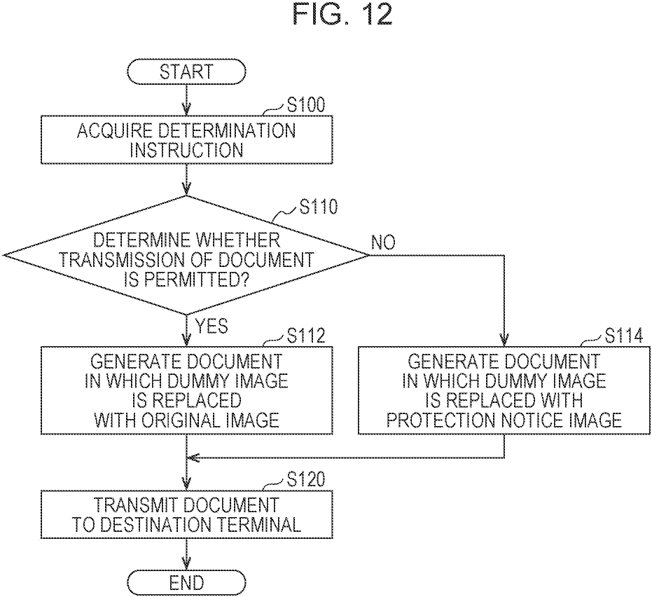

FIG. 12 is a flowchart illustrating a flow example of the protection process of the undetermined document 5 performed by the CPU 51 in the information processing apparatus 20 of the second exemplary embodiment when the information processing apparatus 20 receives the determination instruction from the administrator terminal 30.

In the same way as in the first exemplary embodiment, the information processing program defining the protection process of the undetermined document 5 is pre-stored on the non-volatile memory 54 in the information processing apparatus 20. The CPU 51 in the information processing apparatus 20 of the second exemplary embodiment reads the information processing program from the non-volatile memory 54 and performs the protection process of the undetermined document 5.

The flowchart of the protection process of the undetermined document 5 in FIG. 12 is different from the flowchart of the protection process of the undetermined document 5 of the first exemplary embodiment in FIG. 7 in that the flowchart in FIG. 12 includes newly added steps S112 and S114 and no path in the determination operation in step S110 is followed in step S120. The rest of the process is identical to the protection process of the undetermined document 5 of the first exemplary embodiment. The following discussion focuses on the difference from the protection process of the undetermined document 5 of the first exemplary embodiment.

If the CPU 51 determines in response to the determination results in step S110 in FIG. 12 that the administrator has determined that the undetermined document 5 is the transmission-permitted document 5, the process proceeds to step S112.

In this case, the CPU 51 is free from the operation to replace the image 4 included in the undetermined document 5 with the dummy image 4A. In step S112, the CPU 51 generates a document 5 where the dummy image 4A attached to the undetermined document 5 in step S85 in the verification process of the document 5 in FIG. 11 is replaced back with the original image 4 included in the undetermined document 5 and the process proceeds to step S120.

FIG. 13 illustrates how the dummy image 4A is replaced back with the original image 4. The CPU 51 changes the dummy image 4A attached to the undetermined document 5 into the image 4 originally included in the undetermined document 5.

On the other hand, If the CPU 51 determines in response to the determination results in step S110 in FIG. 12 that the administrator has determined that the undetermined document 5 is not the transmission-permitted document 5, the process proceeds to step S114.

In such a case, the image 4 included in the undetermined document 5 is set to be confidential. In step S114, the CPU 51 generates a document 5 where the dummy image 4A attached to the undetermined document 5 in step S85 in the verification process of the document 5 in FIG. 11 is replaced back with a transmission-not-permitted image 4 (hereinafter referred to as a protection notice image 4B) and the process proceeds to step S120. The document 5 with the dummy image 4A, attached to the undetermined document 5, replaced with the protection notice image 4B is an example of protection image data.

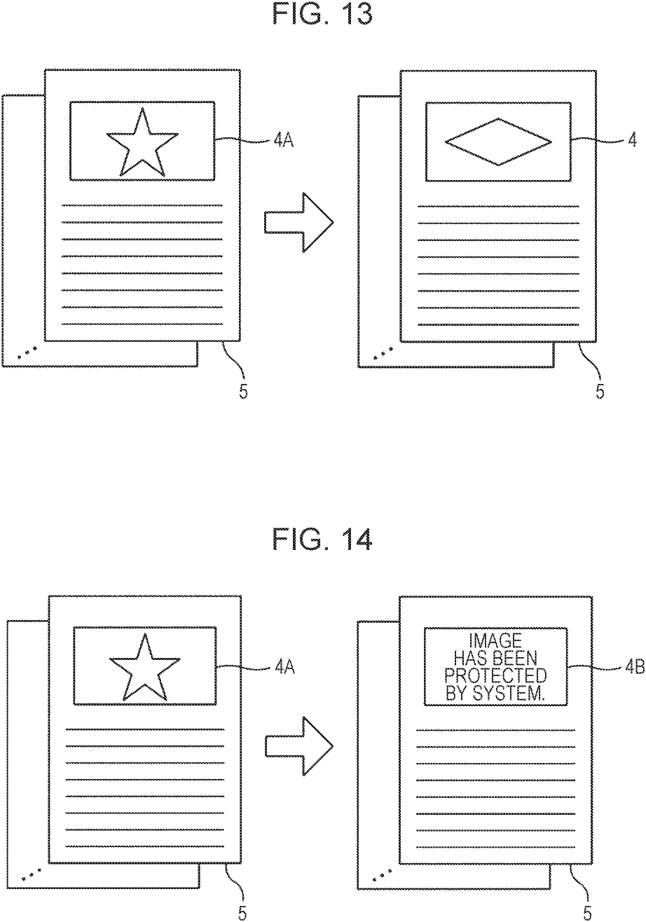

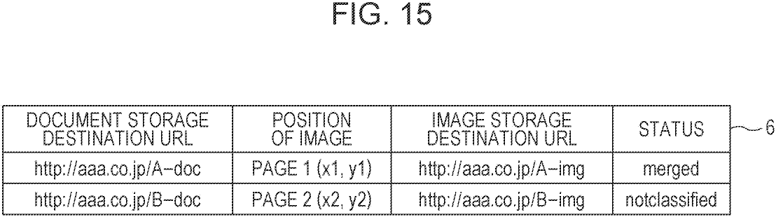

FIG. 14 illustrates how the dummy image 4A is replaced with the protection notice image 4B. The protection notice image 4B is an image 4 that is pre-stored on the non-volatile memory 54 and includes, for example, a message reading “Image has been protected by system.”

If the dummy image 4A is replaced with the original image in step S112 or if the dummy image 4A is replaced with the protection notice image 4B in step S114, the CPU 51 changes to “merged” the status of the document attribute information 6 in the undetermined document 5 serving as a replacement target of the dummy image 4A.

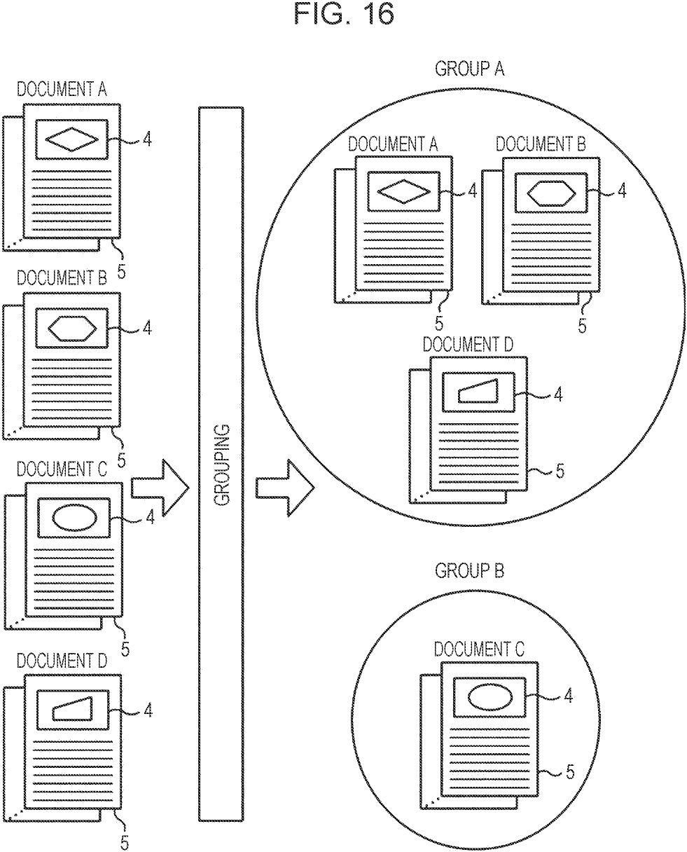

FIG. 15 illustrates an example of the document attribute information 6 on the undetermined document 5 with the dummy image 4A replaced with another image 4. Referring to FIG. 15, the document attribute information 6 with the status “merged” is the document attribute information 6 on the undetermined document 5 with the dummy image 4A replaced with the other image 4. The status “merged” of the document attribute information 6 indicates the replacement performed to the dummy image 4A of the undetermined document 5.

In step S120, the CPU 51 transmits to the destination terminal 40 the document 5 with the dummy image 4A replaced with the original image 4 or the protection notice image 4B.

If there are multiple undetermined documents 5 with the images 4 that are difficult to determine in terms of the confidential target in accordance with the policy 3, the information processing apparatus 20 may group the undetermined documents 5 according to a similarity of an image 4 included in a corresponding undetermined document 5 and present the grouped undetermined documents 5 to the administrator terminal 30 on each of the images 4.

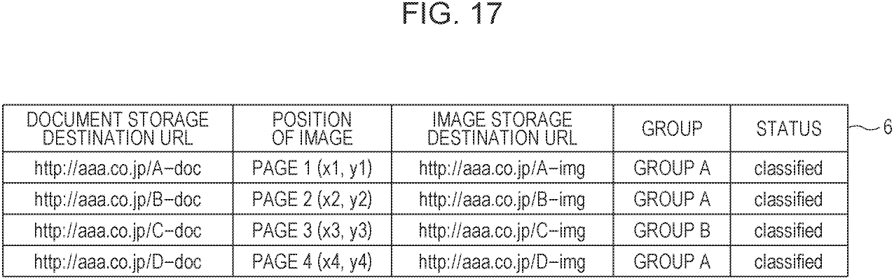

FIG. 16 illustrates how multiple undetermined documents 5 are grouped. In step S85 of the verification process of the document 5 in FIG. 11, the CPU 51 may perform unsupervised learning (such as cluster analysis) on the image 4 included in each undetermined document 5 to group images 4 having similar feature values into the same group and may replace the image 4 included in each undetermined document 5 with the dummy image 4A. Referring to FIG. 16, four undetermined documents 5, namely, documents A, B, C and D are grouped into a group A and group B.

When the undetermined documents 5 are grouped into multiple groups, the CPU 51 adds a group column to the document attribute information 6 and sets a group item to the column.

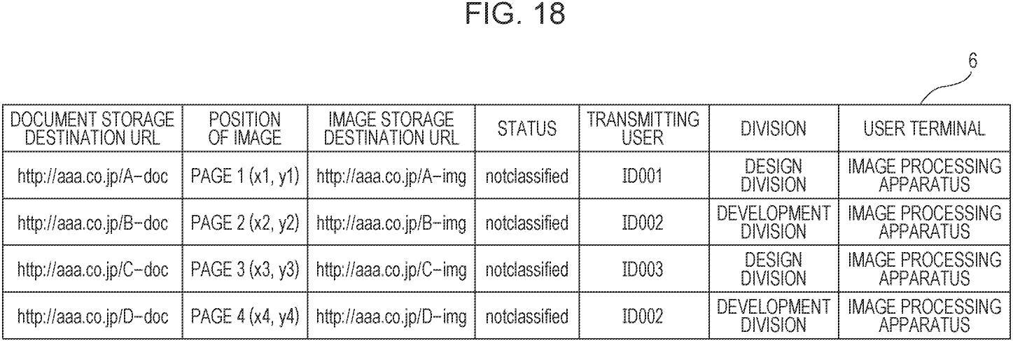

FIG. 17 illustrates an example of the document attribute information 6 with respect to four undetermined documents 5 grouped and indicated in FIG. 16. With reference to the grouping of the document attribute information 6 in FIG. 17, information indicating the group of each undetermined document 5 may be obtained. If the undetermined documents 5 are grouped, the status of the document attribute information 6 is set to be “classified.”

The CPU 51 may group the undetermined documents 5 using supplementary information on the documents 5 in place of or together with the features of the images 4. For example, the CPU 51 may group the undetermined documents 5 using a similarity related to at least one piece of information selected from the group consisting of a transmitting user that has transmitted the document 5 from the user terminal 10, a division or an organization to which the transmitting user belongs, a receiving user that has received the document 5 from the user terminal 10, reception time of the document 5, the user terminal 10 used to transmit the document 5, and the destination terminal 40 receiving the document 5. The transmitting user is an example of a sender of image data and the receiving user is an example of a receiver. The user terminal 10 used to transmit the document 5 is an example of a device of a transmitting source and the destination terminal 40 receiving the document 5 is an example of a device of a destination.

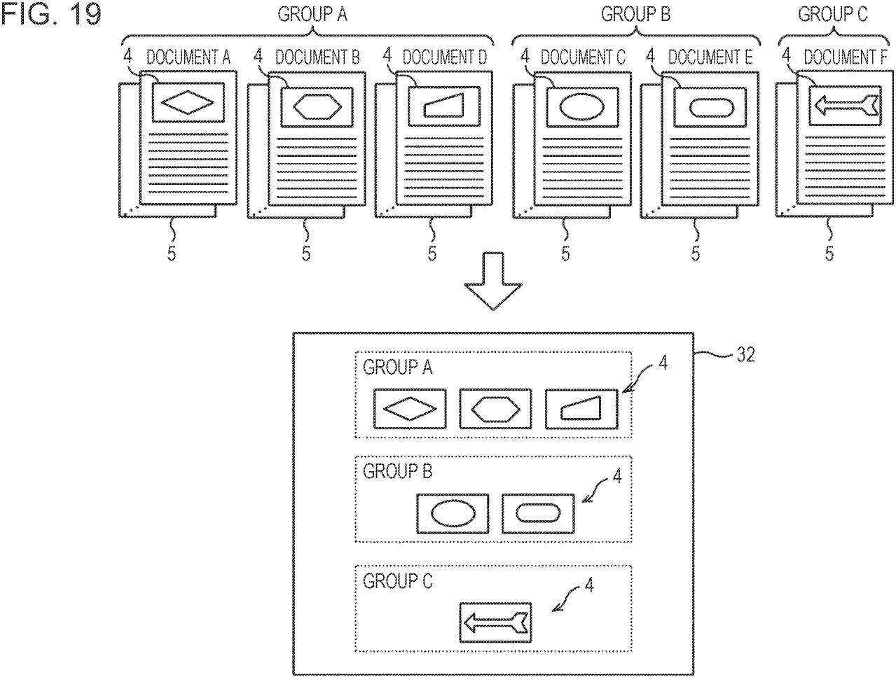

If the undetermined documents 5 are grouped according to the supplementary information on the documents 5, the CPU 51 may simply store, as the document attribute information 6 on each document 5, information used to group the undetermined documents 5 as illustrated in FIG. 18. In the example of the document attribute information 6 illustrated in FIG. 18, the transmitting user is represented using a user identification (ID) uniquely assigned to the transmitting user. Information related to the user ID and a division the user belongs to, and information related to the model and type of the user terminal 10 may be information attached to the document 5 received from the user terminal 10.

As previously described, the administrator terminal 30 verifies the original image 4 of the received undetermined document 5 prior to being replaced with the dummy image 4A and determines whether the undetermined document 5 is a document 5 not including the image 4 serving as the confidential target and is transmission-permitted. When the undetermined documents 5 are grouped as descried above, the CPU 51 performs control such that the image 4 in a group including a larger number of undetermined documents 5 is presented with a higher priority to a display 32 of the administrator terminal 30 in response to an acquisition request for the original image 4 prior to being replaced with the dummy image 4A.

FIG. 19 illustrates a display example displayed on the display 32 of the administrator terminal 30 when the grouped undetermined documents 5 are transmitted to the administrator terminal 30.

Since the number of undetermined documents 5 decreases in the order (of from larger to smaller) of group A, group B, and group C as illustrated in FIG. 19, the images 4 included in the undetermined documents 5 are presented in the order of group A, group B, and group C on the display 32 of the administrator terminal 30.

As already described, the definition of the policy 3 may be difficult in the early stage of development of the apparatus and the image 4 as the confidential target may be unintentionally leaked to the outside because of imperfection of the policy 3. Specifically, more image 4 as the confidential target may be leaked to the outside in the early stage of development of the apparatus than in a subsequent stage of development. On the other hand, there is a tendency that a similarity unique to each stage is noticed in the feature of the image 4 and the supplementary information related to the document 5 at the stage. Mass leakage of the confidential information at a specific stage where the policy 3 is difficult to define may be controlled by allowing the administrator to verify the images 4 in the groups having the undetermined documents 5, in the order of from larger to smaller number of undetermined documents 5 included in the groups.

The grouped images 4 are presented on the display 32 of the administrator terminal 30. In comparison with when the images 4 are presented in a random fashion, the administrator may thus easily determine whether the image 4 is a confidential target. Instead of determining on each image 4 whether the image 4 is a confidential target, the administrator may determine on a per group basis whether the images 4 are confidential targets.

### Third Exemplary Embodiment

When the administrator may determine whether the undetermined document 5 does not include the image 4 serving as a confidential target and is thus a transmission-permitted document 5, the administrator may add a policy 3 in view of the determination results such that the policy 3 helps determine whether the image 4 included in the undetermined document 5 is confidential information. However, this operation is time consuming.

In place of the administrator, an information processing apparatus 20 of a third exemplary embodiment adds the policy 3 that is used to determine in accordance with the determination results of the administrator whether the image 4 is a confidential target.

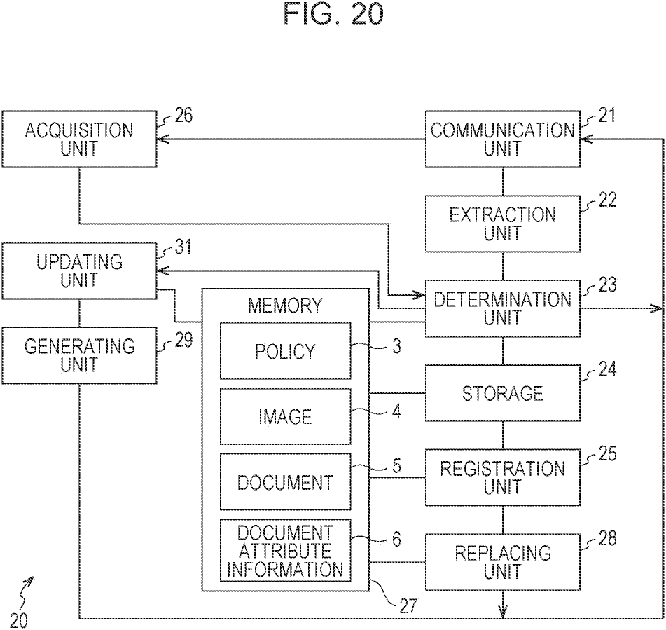

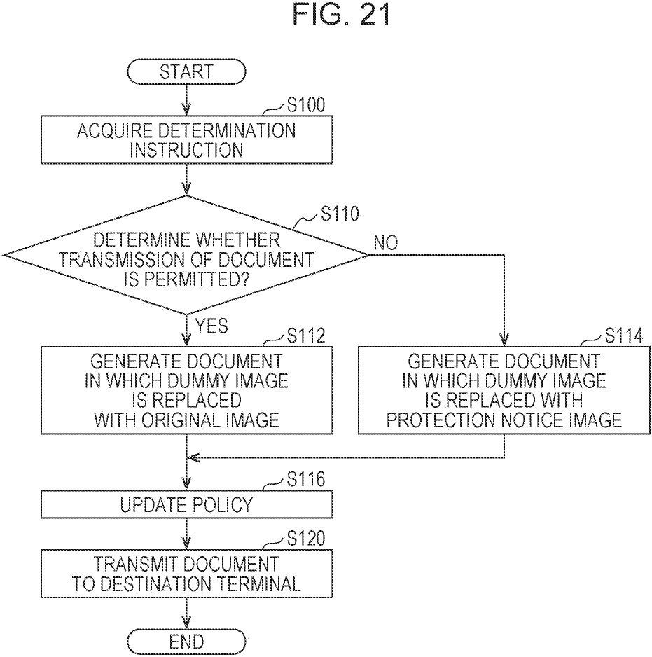

FIG. 20 illustrates a functional configuration of the information processing apparatus 20 of the third exemplary embodiment. The functional configuration in FIG. 20 is different from the functional configuration of the information processing apparatus 20 of the second exemplary embodiment in FIG. 8 in that the functional configuration in FIG. 20 includes an updating unit 31.

In response to the reception of the determination instruction from the administrator terminal 30, the updating unit 31 performs an update operation to add, to the present policy 3, a policy 3 that is used to determine in accordance with the determination results included in the determination instruction whether the image 4 included in the undetermined document 5 is a confidential target.

Since an electrical configuration of the information processing apparatus 20 of the third exemplary embodiment is identical to the electrical configuration of the information processing apparatus 20 of the first exemplary embodiment in FIG. 3, the discussion of the electrical configuration of the information processing apparatus 20 of the third exemplary embodiment is omitted herein. Also, since the verification process of the document 5 performed by the information processing apparatus 20 of the third exemplary embodiment is identical to the verification process of the document 5 of the second exemplary embodiment in FIG. 11, the discussion the verification process of the document 5 of the third exemplary embodiment is omitted herein.

As described below, the information processing apparatus 20 of the third exemplary embodiment performs the protection process of the undetermined document 5 when the determination instruction is received from the administrator terminal 30.

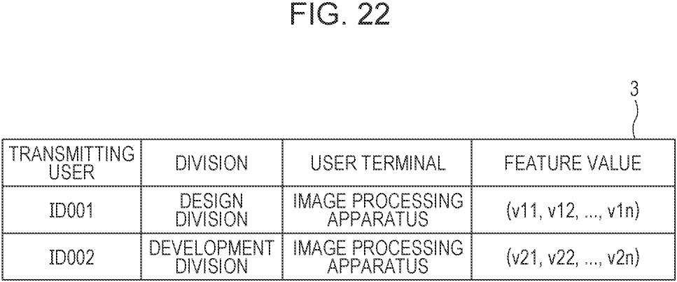

FIG. 21 is a flowchart illustrating a flow example of the protection process of the undetermined document 5 performed by the CPU 51 in the information processing apparatus 20 of the third exemplary embodiment when the information processing apparatus 20 receives the determination instruction from the administrator terminal 30.

In the third exemplary embodiment, as in the first and second exemplary embodiments, the information processing program defining the protection process of the undetermined document 5 is pre-stored on the non-volatile memory 54 in the information processing apparatus 20. The CPU 51 in the information processing apparatus 20 of the third exemplary embodiment reads the information processing program from the non-volatile memory 54 and performs the protection process of the undetermined document 5.

The flowchart of the protection process of the undetermined document 5 in FIG. 21 is different from the flowchart of the protection process of the undetermined document 5 of the second exemplary embodiment in FIG. 12 in that step S116 is added in the flowchart of the protection process of the undetermined document 5 in FIG. 21. The rest of the protection process of the undetermined document 5 in FIG. 21 is identical to the protection process of the undetermined document 5 of the second exemplary embodiment. The following discussion focuses on the difference from the protection process of the undetermined document 5 of the second exemplary embodiment.

The CPU 51 proceeds to step S116 after replacing the dummy image 4A with the original image 4 in step S112 or after replacing the dummy image 4A with the protection notice image 4B in step S114.

If the administrator has determined in the determination operation in step S110 that the undetermined document 5 is a transmission-permitted document 5, the CPU 51 in step S116 adds to the present policy 3 a policy 3 used to determine that the image 4 included in the undetermined document 5 is not an image 4 serving as the confidential target. If the CPU 51 determines that the administrator has determined in the determination operation in step S110 that the undetermined document 5 is not a transmission-permitted document 5, the CPU 51 adds to the present policy 3 a policy 3 used to determine that the image 4 included in the undetermined document 5 is the image 4 serving as the confidential target.

Specifically, the CPU 51 extracts the feature value of the image 4 included in the undetermined document 5 and if the undetermined document 5 is a transmission-permitted document 5, the CPU 51 adds the feature value of the image 4 to the white list. If the undetermined document 5 is not a transmission-permitted document 5, the CPU 51 adds the feature value of the image 4 to the black list.

FIG. 22 illustrates an example of the policy 3. The policy 3 may include the supplementary information set on the extracted image 4 in addition to the feature value of the image 4. The supplementary information may include the transmitting user having transmitted the document 5, the division to which the user having transmitted the document 5 belongs, and the type of the user terminal 10 having transmitted the document 5. The feature value of the image 4 may be represented by a one-dimensional array of elements of a feature vector.

If not only the feature value of the image 4 but also the supplementary information is set in the policy 3, the CPU 51 may determine in view of the similarity of the feature value and the similarity of the supplementary information whether the image 4 serving as a determination target about confidentiality is to be included in the white list or the black list.

The extended policy 3 may thus be obtained without reviewing the definition thereof. The resulting policy 3 may thus determine whether the image 4 similar to an image 4 included in the undetermined document 5 that is determined by the administrator in terms of whether to permit the transmission is an image 4 serving as a confidential target.

If the information processing apparatus 20 receives from the administrator terminal 30 the results of determination on a per group basis as to whether the images 4 are the confidential target, the CPU 51 may extract a feature value common on each group and then add the extracted feature value to the white list or the black list.

As described above, the information processing apparatus 20 of the second exemplary embodiment adds the policy 3 of the image 4 responsive to the determination results of the administrator. However, the addition of the policy 3 of the image 4 may be applied to the protection process of the undetermined document 5 in the information processing apparatus 20 of the first exemplary embodiment illustrated in FIG. 7. Specifically, the CPU 51 may perform the operation in step S116 in FIG. 21 as a final step of the protection process of the undetermined document 5 in FIG. 7.

According to the first through third embodiments, the non-volatile memory 54 in the information processing apparatus 20 stores the policy 3, image 4, document 5 and document attribute information 6. However, the policy 3, image 4, document 5 and document attribute information 6 are not necessarily stored on the non-volatile memory 54 in the information processing apparatus 20. At least one piece of information selected from the group consisting of the policy 3, image 4, document 5, and document attribute information 6 may be stored, for example, on a file server (not illustrated) connected to the communication network 2.

The exemplary embodiments of the information processing apparatuses 20 have been specifically described. The configurations of the information processing apparatuses 20 are disclosed for exemplary purposes only and not limited to the scope of the described exemplary embodiments. A variety of modifications and improvements may be made on the exemplary embodiments without departing from the scope of the disclosure and modified and improved exemplary embodiments fall within the technical scope of the disclosure. For example, without departing from the scope of the disclosure, the order of operations in the verification process of the document 5 illustrated in FIGS. 4, 9 and 11 and the order of operations in the protection process of the undetermined document 5 illustrated in FIGS. 7, 12, and 21 may be modified.

According to the exemplary embodiments, each process is implemented using software. The processes of the flowcharts in FIGS. 4, 7, 9, 11, 12 and 21 may be implemented using hardware. In such a case, higher processing speed may be achieved than when each process is implemented using software.

According to the exemplary embodiments, the information processing program is stored on the non-volatile memory 54. The storage destination of the information processing program is not limited to the non-volatile memory 54. The information processing program of the exemplary embodiments may be delivered in a recorded form on a recording medium readable by the computer 50. For example, the information processing program may be delivered in a recorded form on an optical disk, such as a compact disk read-only memory (CD-ROM) or a digital versatile disk read-only memory (DVD-ROM). The information processing program may also be delivered in a recorded form on a removable semiconductor memory, such as a universal serial bus (USB) memory or a memory card. The ROM 52, non-volatile memory 54, CD-ROM, DVD-ROM, USB memory, and memory card are examples of non-transitory computer readable recording medium.

The information processing apparatus 20 may download the information processing program from an external apparatus (not illustrated) via the communication network 2 and stores the downloaded information processing program on the memory device. In such a case, the CPU 51 in the information processing apparatus 20 reads the information processing program downloaded from the external apparatus and then performs each process.

In the exemplary embodiments above, the term “processor” refers to hardware in a broad sense. Examples of the processor include general processors and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

An appendix related to the disclosure is described below.

(())An information processing apparatus including:
a processor configured to:
   acquire image data with a destination;
   acquire a condition that is pre-defined as to whether image data transmission is permitted or not; and
   if whether the image data transmission is permitted or not is difficult to determine in accordance with the condition, perform control not to transmit the image data to the destination but to present the condition to an administrator that manages the condition.

(())In the information processing apparatus according to (((1))), the processor is configured to, if whether the image data transmission is permitted or not is difficult to determine in accordance with the condition, perform control to transmit, to the destination, dummy image data in which an image portion of the image data is replaced with a dummy image.

(()) In the information processing apparatus according to (((1))), the processor is configured to, if the administrator determines that the image data transmission is permitted, perform control to transmit the image data to the destination.

()In the information processing apparatus according to (((3))), the processor is configured to, if the administrator determines that the image data transmission is not permitted, perform control to transmit, to the destination, protection image data in which an image portion of the image data is replaced with an image indicative of being transmission-not-permitted.

(()) In the information processing apparatus according to any one of (((1))) to (((4))), the processor is configured to, if the administrator determines that the image data transmission is permitted, add a condition that defines the image data as being transmission-permitted.

(()) In the information processing apparatus according to (((5))), the processor is configured to, if the administrator determines that the image data transmission is not permitted, add a condition that defines the image data as being transmission-not-permitted.

(())In the information processing apparatus according to (((5))) or (((6))), the image data includes multiple pieces of data, and the processor is configured to: if whether the image data transmission is permitted or not is difficult to determine in accordance with the condition, group the pieces of the image data in accordance with a similarity of an image portion included in the image data; and perform control to present the grouped image data to the administrator.

(())In the information processing apparatus according to (((7))), the grouping is performed in accordance with a feature value of the image data.

(()) In the information processing apparatus according to (((7))), the grouping is performed in accordance with at least one of a sender of the image data, a receiver of the image data, a device of a transmitting source, or a device of a destination.

(()) In the information processing apparatus according to any one of (((7))) to (((9))), the processor is be configured to perform control to present the grouped image data with a higher priority placed on a group having a higher amount of the image data.

(()) A program for information processing, the program including:
acquiring image data with a destination;
acquiring a condition that is pre-defined as to whether image data transmission is permitted or not; and
if whether the image data transmission is permitted or not is difficult to determine in accordance with the condition, performing control not to transmit the image data to the destination but to present the condition to an administrator that manages the condition.

What is claimed is:

1. An information processing apparatus comprising:
a processor configured to:
acquire image data with a destination;
acquire a condition that is pre-defined as to whether image data transmission is permitted or not; and
if whether the image data transmission is permitted or not is difficult to determine in accordance with the condition, perform control not to transmit the image data to the destination but to present the condition to an administrator that manages the condition.

2. The information processing apparatus according to claim 1, wherein the processor is configured to, if whether the image data transmission is permitted or not is difficult to determine in accordance with the condition, perform control to transmit, to the destination, dummy image data in which an image portion of the image data is replaced with a dummy image.

3. The information processing apparatus according to claim 1, wherein the processor is configured to, if the administrator determines that the image data transmission is permitted, perform control to transmit the image data to the destination.

4. The information processing apparatus according to claim 3, wherein the processor is configured to, if the administrator determines that the image data transmission is not permitted, perform control to transmit, to the destination, protection image data in which an image portion of the image data is replaced with an image indicative of being transmission-not-permitted.

5. The information processing apparatus according to claim 1, wherein the processor is configured to, if the administrator determines that the image data transmission is permitted, add a condition that defines the image data as being transmission-permitted.

6. The information processing apparatus according to claim 5, wherein the processor is configured to, if the administrator determines that the image data transmission is not permitted, add a condition that defines the image data as being transmission-not-permitted.

7. The information processing apparatus according to claim 5, wherein the image data includes a plurality of pieces of data, and
wherein the processor is configured to:
if whether the image data transmission is permitted or not is difficult to determine in accordance with the condition, group the pieces of the image data in accordance with a similarity of an image portion included in the image data; and
perform control to present the grouped image data to the administrator.

8. The information processing apparatus according to claim 6, wherein the image data includes a plurality of pieces of data, and
wherein the processor is configured to:
if whether the image data transmission is permitted or not is difficult to determine in accordance with the condition, group the pieces of the image data in accordance with a similarity of an image portion included in the image data; and
perform control to present the grouped image data to the administrator.

9. The information processing apparatus according to claim 7, wherein the grouping is performed in accordance with a feature value of the image data.

10. The information processing apparatus according to claim 8, wherein the grouping is performed in accordance with a feature value of the image data.

11. The information processing apparatus according to claim 7, wherein the grouping is performed in accordance with at least one of a sender of the image data, a receiver of the image data, a device of a transmitting source, or a device of a destination.

12. The information processing apparatus according to claim 8, wherein the grouping is performed in accordance with at least one of a sender of the image data, a receiver of the image data, a device of a transmitting source, or a device of a destination.

13. The information processing apparatus according to claim 7, wherein the processor is configured to perform control to present the grouped image data with a higher priority placed on a group having a higher amount of the image data.

14. The information processing apparatus according to claim 8, wherein the processor is configured to perform control to present the grouped image data with a higher priority placed on a group having a higher amount of the image data.

15. A non-transitory computer readable medium storing a program causing a computer to execute a process processing information, the process comprising:
acquiring image data with a destination;
acquiring a condition that is pre-defined as to whether image data transmission is permitted or not; and
if whether the image data transmission is permitted or not is difficult to determine in accordance with the condition, performing control not to transmit the image data to the destination but to present the condition to an administrator that manages the condition.

16. An information processing method comprising:
acquiring image data with a destination;
acquiring a condition that is pre-defined as to whether image data transmission is permitted or not; and
if whether the image data transmission is permitted or not is difficult to determine in accordance with the condition, performing control not to transmit the image data to the destination but to present the condition to an administrator that manages the condition.
